(19) United States
(12) Patent Application Publication
(10) Pub. No.: US 2006/0085266 A1
(43) Pub. Date: Apr. 20, 2006

(54) RFID system of restaurant automation

(75) Inventors: Chang Wei, Hsinchu City (TW); Lin Yi-Tang, Tainan City (TW); Wang Jen-Chieh, Jhubei City (TW); Chen Xherry, Ji-an Township (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 10/986,886

(22) Filed: Nov. 15, 2004

(30) Foreign Application Priority Data
Sep. 10, 2004 (TW) 93127376

(51) Int. Cl. G06Q 30/00

(52) U.S. Cl. 705/15

(57) ABSTRACT

The restaurant ordering system employing RFID of the invention comprises a central database, at least an ordering device, at least a serving device, at least a managing device, at least a RFID customer tag, and at least a RFID dish tag, wherein, the central database is used for storing customer information, personalized menus for frequent customers, payment programs, customer codes and dish codes; the order device further comprises a display and a RFID reader; the serving device further comprises a display and a RFID reader; the managing device further comprises a display and a RFID reader; the RFID customer tag is being used as the customer code; the RFID dish tag is being used as the dish code; and the central database, the ordering device, the serving device and the managing device are connected by an Ethernet.

### 1. FIELD OF THE INVENTION

The present invention relates to a restaurant automation system, and more particularly, to a restaurant automation system employing radio frequency identification (RFID) technology to increase operation efficiency.

### 2. BACKGROUND OF THE INVENTION

As the fast path of our modern lifer style, none of us can afford to waste time that we are accustomed to do everything with the ideas of fast and efficient constantly in our mind. In this regard, a new breed of quick service restaurant (QSR), such as a fast food café, has becoming more and more popular that forces the conventional so-called full service restaurants to take the matter seriously and try to improve their service efficiency. However, both the QSR and conventional restaurants still suffer the shortcomings listed as following:
(1) It requires a certain period of time for a new customer of a restaurant to get familiar with the menu thereof until he/she is ready to order while a waiter is waiting, such that the waiter is occupied and doing nothing while another customer will have to wait for another available waiter to take his/her order.
(2) There is no historical patron information available for provide personalized menu for a patron, or personalizing a menu according to the liking of a customer.
(3) In many traditional restaurants, a larger percentage of time is actually spent for a waiter traveling between the table of a customer and the kitchen for handing the order to the kitchen.
(4) Complains about the wrong order are often happened while a waiter is serving many customers at a time.

Currently, a restaurant automation system (RAS) is available for solving the abovementioned shortcomings as seen in FIG. 1, which the restaurant automation system 1 is comprised of a portable E-Menu 11, a kitchen order display 12, a table call unit 13, a payment station 14 and a wireless LAN 15, wherein the portable E-Menu 11, the kitchen order display 12, the table call unit 13, and the payment station 14 are connected by way of the wireless LAN 15. In addition, the portable E-Menu 11 further comprises a table ID 111, and the table call unit 13 further comprises a RFID reader 131. The customers may summon a waiter at will by using the table call unit 13 to scan the E-Menu 11 for enabling the RFID reader 131 to recognize the tale ID 111 and issue a signal indicating through the wireless LAN 15 to the service staff. Using the E-menus, each of the customers may explore the menu, requesting details on any particular menu item, place and confirm an order, follow the status of an order, etc. However, the current RAS still can not integrate every functionality required in a highly efficient restaurant that it is still in need of improvement.

### SUMMARY OF THE INVENTION

The primary object of the invention is to provide a RFID system of restaurant automation, capable of specifying and identifying a customer for providing the customer with personalized services, such as a special menu basing on the dining pattern thereof, a custom-made greeting, and a patronage record, and so on.

It is another object of the invention to provide a RFID system of restaurant automation, which attaches a RFID tag on each dish of a restaurant enabling each order to be meet with exact dishes so as to enhance the efficiency of the serving operation.

Yet, another object of the invention is to provide a restaurant automation system using RFID for automating the process of bill payment.

To achieve the above objects, the present invention provides a RFID system of restaurant automation, comprising: a restaurant ordering system, a restaurant ordering method, an order serving method and a bill paying method.

The restaurant ordering system of the invention comprises a central database, at least an ordering device, at least a serving device, at least a managing device, at least a RFID customer tag, and at least a RFID dish tag, wherein, the central database is used for storing customer information, personalized menus for frequent customers, payment programs, customer codes and dish codes; the order device further comprises a display and a RFID reader; the serving device further comprises a display and a RFID reader; the managing device further comprises a display and a RFID reader; the RFID customer tag is being used as the customer code; the RFID dish tag is being used as the dish code; and the central database, the ordering device, the serving device and the managing device are connected by an Ethernet.

The restaurant ordering method comprises the steps of:
(a) providing a restaurant ordering system employing RFID to a restaurant, and the system comprising a central database, at least an ordering device, at least a serving device, and at least a RFID customer tag, wherein the central database, the ordering device, the serving device are connected by an Ethernet;
(b) providing at least a customer operating the ordering device for enabling the central database to make an evaluation to determine whether the personal information of the customer is stored in the central database;
(c) processing the filing of personal information of the customer and issuing a RFID tag as the customer code of the customer while detecting no relevant personal information of the customer in the central database;
(d) repeating the steps (b) and (c) after a new RFID customer tag is issued;
(e) inputting the RFID custom tag to the ordering device by the customer for acknowledging the central database with the RFID customer tag through the Ethernet while the personal information is already stored in the central database;
(f) displaying a custom-made greeting and a personalized menu on the display of the ordering device indicating the entering of the restaurant ordering system; and
(g) inputting an order of the customer by selecting from the personalized menu shown on the display, wherein the order of the customer is transmitted to the serving device through the Ethernet.

The order serving method comprises the steps of:
(a) providing a restaurant ordering system employing RFID to a restaurant, and the system comprising a central database, at least an ordering device installed in a table of a restaurant, at least a serving device arranged in the kitchen of the restaurant, and at least a RFID dish tag disposed on a dining plate, wherein the central database, the ordering device, the serving device are connected by an Ethernet;
(b) providing at least a customer operating the ordering device for inputting the information of an order where the information of the order is being transmitted to the serving device and the central database;
(c) preparing and placing the order on a dining plate while the kitchen of the restaurant receives the information of the order through the serving device;
(d) placing the dining plate on the serving device for reading and transmitting the information of the dining plate to the central database through a Ethernet while serving the order;
(e) placing the dining plate on the ordering device for reading and transmitting the information of the dining plate to the central database through a Ethernet while the order is served to the table;
(f) making an evaluation at the central database to determine whether the information of the dining plate matches with the information of the order;
(g) representing the order is served and eliminating the information of the dining plate from the information of the order while the information of the dining plate matches with the information of the order; and
(h) displaying a “wrong order” message on the ordering device, notifying the kitchen for preparing the correct order by a waiter and repeating steps (c) to step (f) while the information of the dining plate is not matched with the information of the order.

The bill paying method comprises the steps of:
(a) providing a restaurant ordering system employing RFID to a restaurant, and the system comprising a central database, at least an ordering device, at least a managing device, and at least a RFID customer tag, wherein the central database, the ordering device, the serving device are connected by an Ethernet, and the central database is adapted for storing customer information, menus and a billing program;
(b) providing at least a customer having a RFID customer tag;
(c) placing the RFID customer tag on the ordering device by the customer for enabling the RFID customer tag to be read by the ordering device and transmitted to the central database through the Ethernet;
(d) displaying a custom-made greeting and a personalized menu on the display of the ordering device indicating the entering of the restaurant ordering system;
(e) inputting an order of the customer by selecting from the personalized menu shown on the display, wherein the order of the customer is transmitted to the central database through the Ethernet;
(f) placing the RFID customer tag on the managing device by the customer while the customer is ready to pay the bill for enabling the billing program resided in the central database to calculate the amount due of the customer by comparing the order of the customer with the personalized menu and show the amount due on the managing device; and
(g) paying the amount due by the customer.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

FIG. 1 is a schematic illustration showing a conventional restaurant automation system.

FIG. 2 is a schematic illustration showing a restaurant ordering system employing RFID according to the present invention.

FIG. 3 is a billing flowchart of a restaurant ordering system employing RFID according to the present invention.

FIG. 3A is a billing flowchart of a restaurant ordering system employing RFID according to the present invention.

FIG. 3B is a billing flowchart of a restaurant ordering system employing RFID according to the present invention.

FIG. 3C is a billing flowchart of a restaurant ordering system employing RFID according to the present invention.

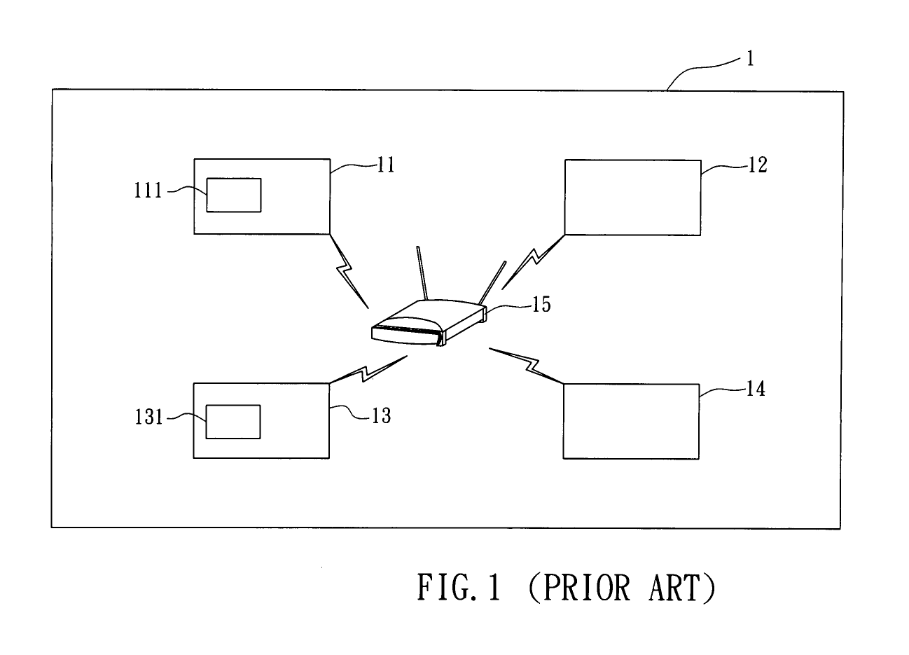

### DESCRIPTION OF THE PREFERRED EMBODIMENT

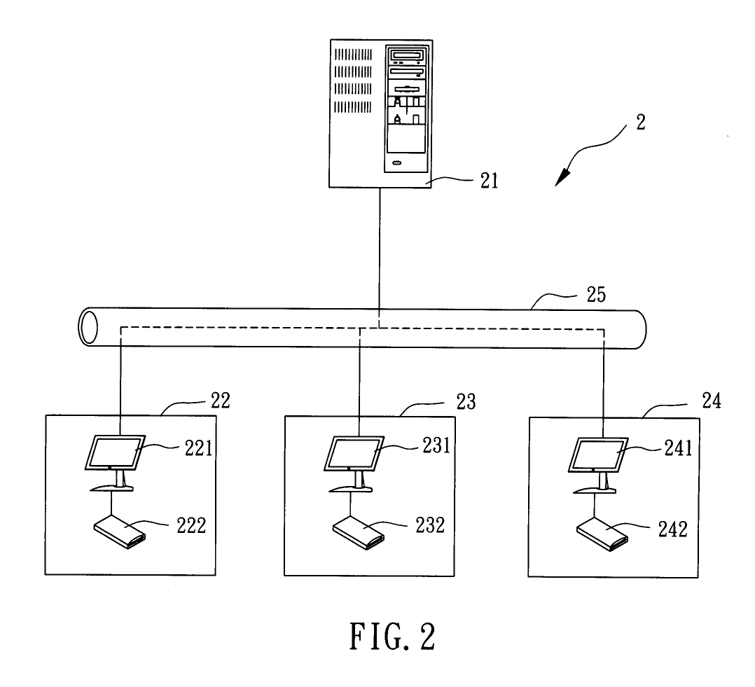

Please refer to FIG. 2, which is a schematic illustration showing a restaurant ordering system employing RFID according to the present invention. The restaurant ordering system 2 of the invention comprises a central database 21, an ordering device 22, a serving device 23, a managing device 24, wherein, the central database 21 is used for storing customer information, personalized menus for frequent customers, payment programs, customer codes and dish codes, and other data and programs relating to restaurant management; the order device 22 further comprises a display 221 and a RFID reader 222; the serving device 23 further comprises a display 231 and a RFID reader 232; the managing device 24 further comprises a display 241 and a RFID reader 242; and the central database 21, the ordering device 22, the serving device 23 and the managing device 24 are connected by an Ethernet 25. In addition, the restaurant order system 2 further comprises a RFID customer tag, and a RFID dish tag, wherein the RFID customer tag is being used as the customer code; the RFID dish tag is being used as the dish code;

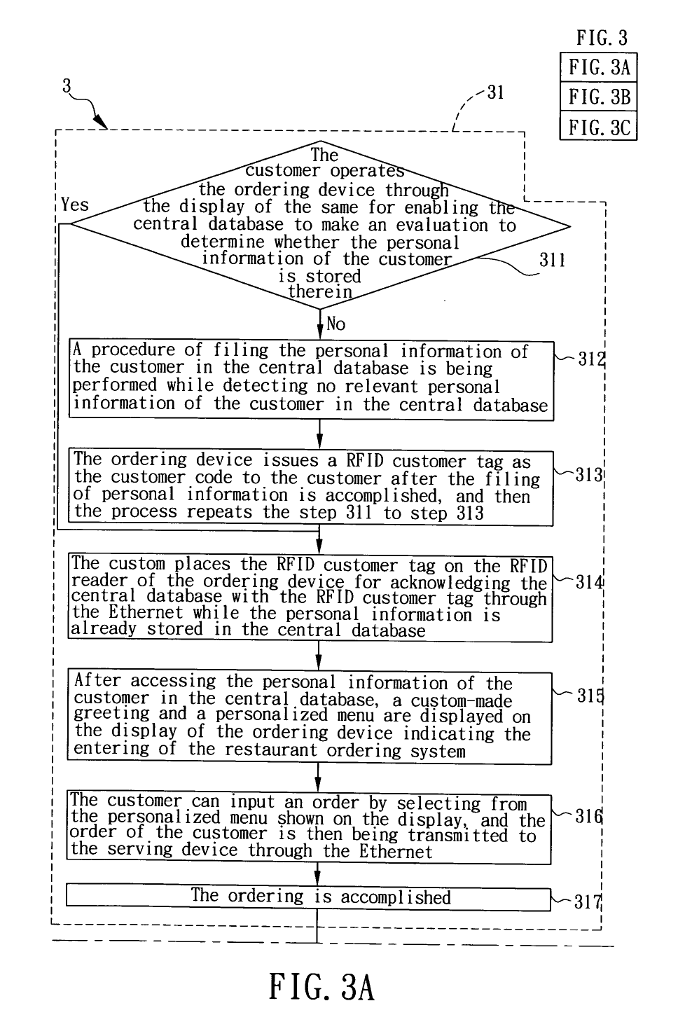

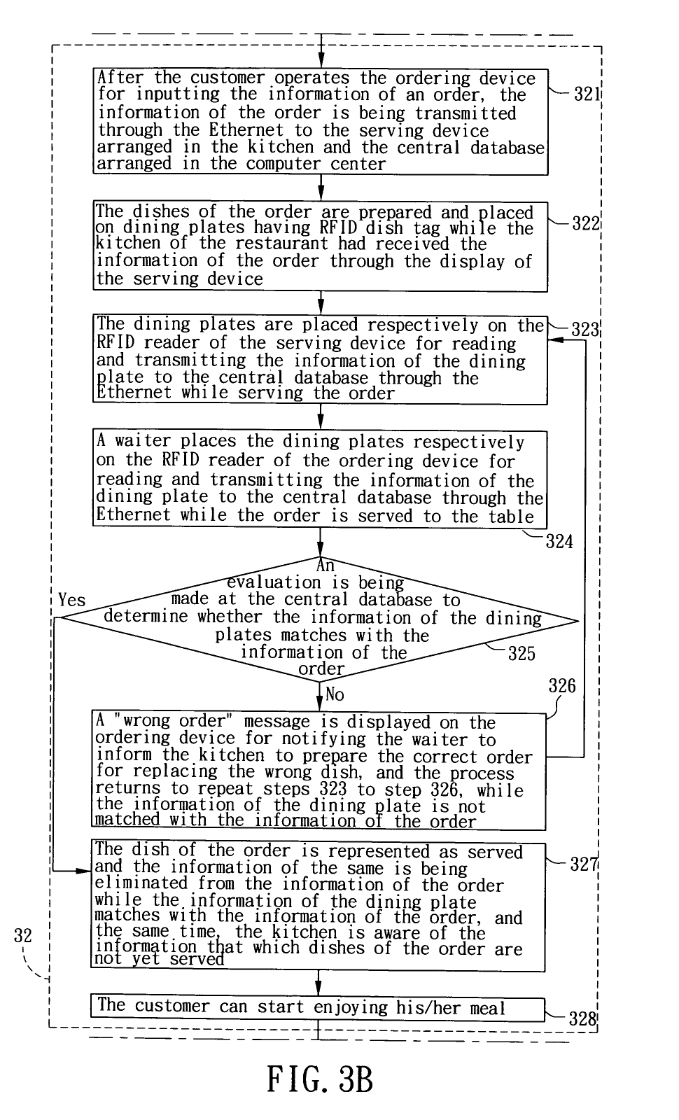

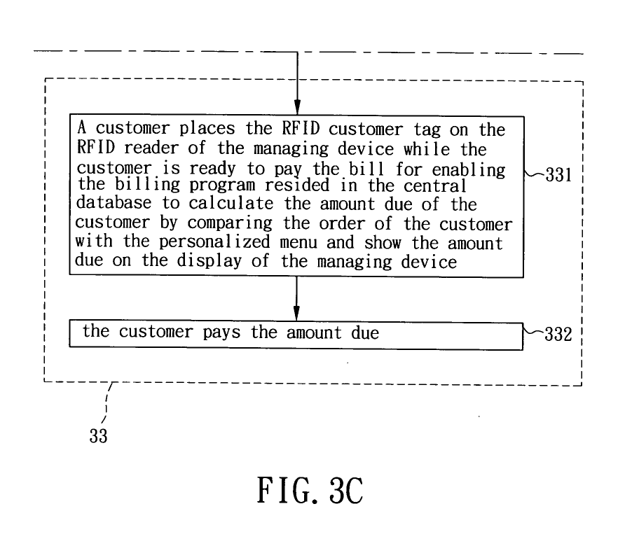

FIG. 3 is a composite diagram of FIG. 3A, FIG. 3B and FIG. 3C in successive, which is a billing flowchart of a restaurant ordering system employing RFID according to the present invention. The flowchart 3 of the invention includes a restaurant ordering method 31, an order serving method 32 and a bill paying method 33. As seen in FIG. 3A, the ordering services provided by a restaurant as soon as a customer entering the restaurant is listed in the following steps:
Step 311: the customer can operate the ordering device through the display of the same for enabling the central database to make an evaluation to determine whether the personal information of the customer is stored therein; if so, the process proceeds to step 304; otherwise, the process proceeds to step 312;
Step 312: a procedure of filing the personal information of the customer in the central database is being performed while detecting no relevant personal information of the customer in the central database;
Step 313: the ordering device issues a RFID customer tag as the customer code to the customer after the filing of personal information is accomplished, and then the process goes back to step 311;
Step 314: the custom places the RFID customer tag on the RFID reader of the ordering device for acknowledging the central database with the RFID customer tag through the Ethernet while the personal information is already stored in the central database;
Step 315: after accessing the personal information of the customer in the central database, a custom-made greeting and a personalized menu can be displayed on the display of the ordering device indicating the entering of the restaurant ordering system, wherein the personalized menu is composed of specific dishes based on patronage frequency and dining pattern enabling the customer to select his/her favorites easily, and related information, such as special discount, calorific capacity, etc., can be displayed along with each dish of the personalized menu as reference;
Step 316: the customer can input an order by selecting from the personalized menu shown on the display, and the order of the customer is then being transmitted to the serving device through the Ethernet;
Step 317: the ordering is accomplished.

FIG. 3B is adapted for illustrating an order serving method 32 which is a follow-up to the step 317 and comprises steps listed as following:
Step 321: after the customer operates the ordering device for inputting the information of an order, the information of the order is being transmitted through the Ethernet to the serving device arranged in the kitchen and the central database arranged in the computer center;
Step 322: the dishes of the order are prepared and placed on dining plates having RFID dish tag while the kitchen of the restaurant had received the information of the order through the display of the serving device;
Step 323: the dining plates are placed respectively on the RFID reader of the serving device for reading and transmitting the information of the dining plate to the central database through the Ethernet while serving the order;
Step 324: a waiter will place the dining plates respectively on the RFID reader of the ordering device for reading and transmitting the information of the dining plate to the central database through the Ethernet while the order is served to the table;
Step 325: an evaluation is being made at the central database to determine whether the information of the dining plates matches with the information of the order; if so, the process proceeds to step 327, otherwise, the process goes to step 326;
Step 326: a “wrong order” message is displayed on the ordering device for notifying the waiter to inform the kitchen to prepare the correct order, and the process returns to repeat steps 323 to step 326 while the information of the dining plate is not matched with the information of the order.
Step 327: the dish of the order is represented as served and the information of the same is being eliminated from the information of the order while the information of the dining plate matches with the information of the order, and the same time, the kitchen is aware of the information that which dishes of the order are not yet served;
Step 328: the customer can start enjoying his/her meal.

FIG. 3C is adapted for illustrating a bill paying method 33 which is a follow-up to the step 328 and comprises steps listed as following:
Step 331: a customer places the RFID customer tag on the RFID reader of the managing device while the customer is ready to pay the bill for enabling the billing program resided in the central database to calculate the amount due of the customer by comparing the order of the customer with the personalized menu and show the amount due on the display of the managing device, wherein the billing program is programmed with special discounts, such as VIP discount and Repeater discount, for facilitating the process of billing;
Step 332: the customer pays the amount due, which can be accomplished either by cash or by credit card.

In a preferred embodiment of the invention, the central database can be arranged in a computer center, the ordering device can be arranged at each table of a restaurant employing the invention, the serving device can be arranged in the kitchen of the restaurant, and the managing device can be arranged in the computer center of the restaurant. In addition, the RFID customer tag is adapted for storing customer personal information, such as patronage frequency and dining pattern, etc., and the RFID dish tag is disposed in the dining plate of the restaurant, e.g. at the bottom of the dining plate, or integrally formed with the dining plate.

In another preferred embodiment of the invention, a credit-card payment mechanism can be integrated with the central database such that the customer can pay his/her bill at the table through a simple and safe identification process without having to walk to the counter for paying the bill. Moreover, an E-money payment mechanism (i.e. smart card) can be integrated with the RFID customer tag such that a customer can go to a restaurant for dining without bringing his/her wallet/purse. In this regard, the implementation of the present invention not only can provide ease of payment for the customers, but also enhance the efficiency of automation and e-management of the restaurant. The present invention hence presents a win-win solution for the restaurant and the dinner.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A restaurant ordering system employing RFID, comprising:
a central database, for storing a data;
at least an ordering device, further comprising a display and a RFID reader;
at least a serving device, further comprising a display and a RFID reader at least a RFID customer tag, acting as a customer code; and
at least a RFID dish tag, acting as a dish code;
wherein, the central database, the ordering device, and the serving device is connected by a Ethernet.

2. The system as recited in claim 1, wherein the system further comprises
at least a managing device having a display and a RFID reader arranged therein.

3. The system as recited in claim 2, wherein the managing device is arranged at the counter of a restaurant.

4. The system as recited in claim 1, wherein the ordering device is arranged at a table of a restaurant.

5. The system as recited in claim 1, wherein the serving device is arranged at the kitchen of a restaurant.

6. The system as recited in claim 1, wherein the RFID customer tag is adapted for storing a data.

7. The system as recited in claim 6, wherein the data is substantially the dining record of a customer.

8. The system as recited in claim 1, wherein the RFID dish tag is arranged at a dining plate of a restaurant.

9. The system as recited in claim 1, wherein the data is substantially the personal information of a customer.

10. The system as recited in claim 1, wherein the data is substantially the personalized menu of a customer.

11. The system as recited in claim 1, wherein the data is substantially a billing program.

12. The system as recited in claim 1, wherein the data is substantially a customer code.

13. The system as recited in claim 1, wherein the data is substantially a dish code.

14. A restaurant ordering method employing RFID, comprising the steps of:
(a) providing a restaurant ordering system employing RFID to a restaurant, and the system comprising a central database, at least an ordering device, at least a serving device, and at least a RFID customer tag, wherein the central database, the ordering device, the serving device are connected by an Ethernet;
(b) providing at least a customer operating the ordering device for enabling the central database to make an evaluation to determine whether the personal information of the customer is stored in the central database;
(c) processing the filing of personal information of the customer and issuing a RFID tag as the customer code of the customer while detecting no relevant personal information of the customer in the central database;
(d) repeating the steps (b) and (c) after a new RFID customer tag is issued;
(e) inputting the RFID custom tag to the ordering device by the customer for acknowledging the central database with the RFID customer tag through the Ethernet while the personal information is already stored in the central database;
(f) displaying a custom-made greeting and a personalized menu on the display of the ordering device indicating the entering of the restaurant ordering system; and
(g) inputting an order of the customer by selecting from the personalized menu shown on the display, wherein the order of the customer is transmitted to the serving device through the Ethernet.

15. The method as recited in claim 14, wherein the ordering device is arranged at a table of a restaurant.

16. The method as recited in claim 14, wherein the serving device is arranged at the kitchen of a restaurant.

17. The method as recited in claim 14, wherein the RFID customer tag is adapted for storing a personal information.

18. The method as recited in claim 17, wherein the personal information is substantially the dining record of a customer.

19. A restaurant serving method employing RFID, comprising the steps of:
(a) providing a restaurant ordering system employing RFID to a restaurant, and the system comprising a central database, at least an ordering device installed in a table of a restaurant, at least a serving device arranged in the kitchen of the restaurant, and at least a RFID dish tag disposed on a dining plate, wherein the central database, the ordering device, the serving device are connected by an Ethernet;
(b) providing at least a customer operating the ordering device for inputting the information of an order where the information of the order is being transmitted to the serving device and the central database;
(c) preparing and placing the order on a dining plate while the kitchen of the restaurant receives the information of the order through the serving device;
(d) placing the dining plate on the serving device for reading and transmitting the information of the dining plate to the central database through a Ethernet while serving the order;
(e) placing the dining plate on the ordering device for reading and transmitting the information of the dining plate to the central database through a Ethernet while the order is served to the table;
(f) making an evaluation at the central database to determine whether the information of the dining plate matches with the information of the order;
(g) representing the order is served and eliminating the information of the dining plate from the information of the order while the information of the dining plate matches with the information of the order; and
(h) displaying a “wrong order” message on the ordering device, notifying the kitchen for preparing the correct order by a waiter and repeating steps (c) to step (f) while the information of the dining plate is not matched with the information of the order.

20. A bill paying method employing RFID, comprising the steps of:
(a) providing a restaurant ordering system employing RFID to a restaurant, and the system comprising a central database, at least an ordering device, at least a managing device, and at least a RFID customer tag, wherein the central database, the ordering device, the serving device are connected by an Ethernet, and the central database is adapted for storing customer information, menus and a billing program;
(b) providing at least a customer having a RFID customer tag;
(c) placing the RFID customer tag on the ordering device by the customer for enabling the RFID customer tag to be read by the ordering device and transmitted to the central database through the Ethernet;
(d) displaying a custom-made greeting and a personalized menu on the display of the ordering device indicating the entering of the restaurant ordering system;
(e) inputting an order of the customer by selecting from the personalized menu shown on the display, wherein the order of the customer is transmitted to the central database through the Ethernet;
(f) placing the RFID customer tag on the managing device by the customer while the customer is ready to pay the bill for enabling the billing program resided in the central database to calculate the amount due of the customer by comparing the order of the customer with the personalized menu and show the amount due on the managing device; and
(g) paying the amount due by the customer.

21.
